(19) United States
(12) Patent Application Publication
(10) Pub. No.: US 2025/0253309 A1
(43) Pub. Date: Aug. 7, 2025

(54) ELECTRODE FOR SECONDARY BATTERY AND LITHIUM SECONDARY BATTERY COMPRISING THE SAME

(71) Applicant: LG ENERGY SOLUTION, LTD., Seoul (KR)

(72) Inventors: In Young SONG, Daejeon (KR); Joo Yul Baek, Daejeon (KR); Jeong Kyu Lee, Daejeon (KR); Sung Joon Oh, Daejeon (KR); Jong Chan Lee, Daejeon (KR)

(21) Appl. No.: 19/186,520

(22) Filed: Apr. 22, 2025

Related U.S. Application Data
(63) Continuation of application No. 16/996,216, filed on Aug. 18, 2020, now Pat. No. 12,308,417.

(30) Foreign Application Priority Data
Aug. 19, 2019 (KR) 10-2019-0101343
Aug. 5, 2020 (KR) 10-2020-0098150

(51) Int. Cl. H01M 4/133; H01M 4/02; H01M 4/36; H01M 4/587; H01M 10/0525

(52) U.S. Cl. CPC H01M 4/133; H01M 4/366; H01M 4/587; H01M 10/0525; H01M 2004/021; H01M 2004/027

(57) ABSTRACT

An electrode for a secondary battery including a current collector, and at least one electrode material mixture layer on a surface of the current collector, the electrode material mixture layer including a negative electrode active material, a conductive agent, and a binder wherein, the electrode has a property such that in a regression curve obtained by regression analysis of shear strength data according to a cutting depth which are measured while obliquely cutting the electrode material mixture layer from a surface thereof until reaching the current collector using a surface and interfacial cutting analysis system (SAICAS), a ratio of a maximum value (σₘₐₓ) to a minimum value (σₘᵢₙ) of shear strength is 1.7 or less.

### CROSS-REFERENCE TO RELATED APPLICATIONS

This application is a continuation of U.S. patent application Ser. No. 16/996,216, filed on Aug. 18, 2020, now allowed, which claims the priority to Korean Patent Application Nos. 10-2019-0101343 filed on Aug. 19, 2019, and 10-2020-0098150 filed on Aug. 5, 2020, in the Korean Intellectual Property Office, the disclosures of which are incorporated herein by reference in their entirety as if fully set forth herein.

### BACKGROUND OF THE INVENTION

### Field of the Invention

The present invention relates to an electrode for a secondary battery and a lithium secondary battery including the same.

### Description of the Related Art

Recently, with the rapid spread of electronic devices using batteries, such as mobile phones, notebook computers, and electric vehicles, demand for secondary batteries with relatively high capacity as well as small size and lightweight has been rapidly increased. Particularly, since a lithium secondary battery is lightweight and has high energy density, the lithium secondary battery is in the spotlight as a driving power source for portable devices. Accordingly, research and development efforts for improving performance of the lithium secondary battery have been actively conducted.

In the lithium secondary battery in a state in which an organic electrolyte solution or a polymer electrolyte solution is filled between a positive electrode and a negative electrode which respectively include active materials capable of intercalating and deintercalating lithium ions, electrical energy is produced by oxidation and reduction reactions when the lithium ions are intercalated/deintercalated into/from the positive electrode and the negative electrode.

With respect to the electrode active material, a conductive agent, and a current collector which constitute the electrode of the lithium secondary battery, bonding forces between the components of the electrode may be increased by a polymer binder, and an exfoliation phenomenon of the electrode may be suppressed during coating, drying, and rolling processes of the electrode. Also, output characteristics may be improved by increasing electrical conductivity through the conductive agent.

However, it is desirable that an amount of the polymer binder having insulator properties in a limited space of the electrode is minimized to increase capacity of the electrode. However, if the amount of the polymer binder is decreased, a cohesive failure phenomenon may occur due to a decrease in binding force. Cohesive failure is a phenomenon in which crack or exfoliation occurs in an electrode material mixture layer because cohesion between binder (adhesive) molecules is lost due to particle breakage or tearing between particle-binder-particle when stress is applied to the electrode due to expansion/contraction during charge and discharge cycles, external impact, etc., wherein battery performance is degraded when the cohesive failure occurs. Also, the binder may be non-uniformly distributed according to process conditions, and, in this case, the cohesive failure may also be caused.

Furthermore, with respect to a multilayer electrode in which electrode active materials, which are respectively advantageous in battery life characteristics, capacity, and strength characteristics, are configured in multi-layers, cohesive failure between electrode layers may occur due to differences in adhesion and strengths of the different electrode active materials, and, accordingly, the life characteristics may be degraded.

Particularly, with respect to a multilayer electrode in which artificial graphite having excellent life characteristics and capacity characteristics and natural graphite having excellent strength and adhesion are formed in multi-layers, it is advantageous for cost reduction while battery characteristics are improved, but cohesive failure, particularly, interlayer cohesive failure in the electrode may occur due to differences in adhesion and strengths between the artificial graphite and the natural graphite, and, accordingly, the life characteristics may be degraded.

### PRIOR ART DOCUMENT

### Patent Document

(Patent Document 1) U.S. Patent Publication No. 2014-0295248

### SUMMARY OF THE INVENTION

An aspect of the present invention provides an electrode for a secondary battery which suppresses the occurrence of cohesive failure, particularly, interlayer cohesive failure in the electrode during operation of the lithium secondary battery and has excellent life characteristics and capacity characteristics while having cost competitiveness.

According to an aspect of the present invention, there is provided an electrode for a secondary battery including a current collector and at least one electrode material mixture layer on a surface of the current collector, the at least one electrode material mixture layer including a negative electrode active material, a conductive agent, and a binder, wherein the electrode has a property such that in a regression curve obtained by regression analysis of shear strength data according to a cutting depth which are measured while obliquely cutting the electrode material mixture layer from a surface thereof until reaching the current collector using a surface and interfacial cutting analysis system (SAICAS), a ratio of a maximum value (σₘₐₓ) to a minimum value (σₘᵢₙ) of shear strength is 1.7 or less.

According to another aspect of the present invention, there is provided a lithium secondary battery including the electrode for a secondary battery.

### BRIEF DESCRIPTION OF THE DRAWINGS

The following drawings attached to the specification illustrate preferred examples of the present invention by example, and serve to enable technical concepts of the present invention to be further understood together with detailed description of the invention given below, and therefore the present invention should not be interpreted only with matters in such drawings.

FIG. 1 is a schematic view illustrating a process of cutting an electrode material mixture layer using a surface and interfacial cutting analysis system;

FIG. 2 is a graph illustrating shear strength data and a regression curve of an electrode according to Example 1;

FIG. 3 is a graph illustrating shear strength data and a regression curve of an electrode according to Example 2;

FIG. 4 is a graph illustrating shear strength data and a regression curve of an electrode according to Example 3;

FIG. 5 is a graph illustrating shear strength data and a regression curve of an electrode according to Comparative Example 1;

FIG. 6 is a graph illustrating shear strength data and a regression curve of an electrode according to Comparative Example 2; and

FIG. 7 is a graph illustrating shear strength data and a regression curve of an electrode according to Comparative Example 3.

### DETAILED DESCRIPTION OF THE PREFERRED EMBODIMENT

Hereinafter, the present invention will be described in more detail to allow for a clearer understanding of the present invention. In this case, it will be understood that words or terms used in the specification and claims shall not be interpreted as the meaning defined in commonly used dictionaries, and it will be further understood that words or terms used in the specification and claims should be interpreted as having a meaning that is consistent with their meaning in the context of the relevant art and the technical idea of the invention, based on the principle that an inventor may properly define the meaning of the words or terms to best explain the invention.

An electrode for a secondary battery of the present invention is an electrode including a current collector and at least one electrode material mixture layer on a surface of the current collector, the at least one electrode material mixture layer including a negative electrode active material, a conductive agent, and a binder, wherein the electrode has a property such that in a regression curve obtained by regression analysis of shear strength data according to a cutting depth which are measured while obliquely cutting the electrode material mixture layer from a surface thereof until reaching the current collector using a surface and interfacial cutting analysis system, a ratio of a maximum value (σₘₐₓ) to a minimum value (σₘᵢₙ) of shear strength is 1.7 or less, preferably 1 to 1.7, and more preferably 1 to 1.6, for example, 1.2 to 1.6.

The electrode for a secondary battery of the present invention may be a negative electrode, and, specifically, may be an electrode with a structure in which an electrode material mixture layer is formed on a current collector. The electrode material mixture layer may include a negative electrode active material, a conductive agent, and a binder.

The electrode material mixture layer may be a single layer, or may be a multilayer-structured electrode including a first electrode material mixture layer and a second electrode material mixture layer formed on the first electrode material mixture layer. For example, the electrode material mixture layer may include a first electrode material mixture layer on a surface of the current collector and including a first negative electrode active material, a first conductive agent, and a first binder, and a second electrode material mixture layer on a surface of the first electrode material mixture layer opposite the current collector and including a second negative electrode active material, a second conductive agent, and a second binder.

The first and second negative electrode active materials, the first and second conductive agents, and the first and second binders, which are included in the first electrode material mixture layer and the second electrode material mixture layer, respectively, may be the same or may be different from each other.

The current collector is not particularly limited as long as it has high conductivity without causing adverse chemical changes in the battery, and, for example, copper, stainless steel, aluminum, nickel, titanium, fired carbon, copper or stainless steel that is surface-treated with one of carbon, nickel, titanium, silver, or the like, and an aluminum-cadmium alloy may be used. Also, the negative electrode collector may typically have a thickness of 3 μm to 500 μm, and, similar to a positive electrode collector, microscopic irregularities may be formed on the surface of the collector to improve the adhesion of the negative electrode active material. The current collector, for example, may be used in various shapes such as that of a film, a sheet, a foil, a net, a porous body, a foam body, a non-woven fabric body, and the like.

The negative electrode active material may be a negative electrode active material commonly used in the art, for example, a carbonaceous material such as natural graphite, artificial graphite, graphitized carbon fibers, and amorphous carbon; a metallic compound alloyable with lithium such as silicon (Si), aluminum (Al), tin (Sn), lead (Pb), zinc (Zn), bismuth (Bi), indium (In), magnesium (Mg), gallium (Ga), cadmium (Cd), a Si alloy, a Sn alloy, or an Al alloy; a metal oxide which may be doped and undoped with lithium such as SiO_{β} (0<β<2), SnO₂, vanadium oxide, and lithium vanadium oxide; or a composite including the metallic compound and the carbonaceous material such as a Si—C composite or a Sn—C composite.

In a case in which the electrode material mixture layer has a multilayer structure of two or more layers, the first negative electrode active material and the second negative electrode active material may each include at least one selected from the group consisting of natural graphite and artificial graphite, and may selectively further include a carbonaceous material such as graphitized carbon fibers and amorphous carbon; a metallic compound alloyable with lithium such as Si, Al, Sn, Pb, Zn, Bi, In, Mg, Ga, Cd, a Si alloy, a Sn alloy, or an Al alloy; a metal oxide which may be doped and undoped with lithium such as SiO_{β} (0<β<2), SnO₂, vanadium oxide, and lithium vanadium oxide; or a composite including the metallic compound and the carbonaceous material such as a Si—C composite or a Sn—C composite.

Preferably, the first negative electrode active material included in the first electrode material mixture layer, as a lower portion of the electrode, may include natural graphite having excellent strength and adhesion, and the second negative electrode active material included in the second electrode material mixture layer, as an upper portion of the electrode, may include artificial graphite having excellent life characteristics and capacity.

The conductive agent, the first conductive agent, and the second conductive agent are used to provide conductivity to the electrode, wherein any conductive agent may be used without particular limitation as long as it has suitable electron conductivity without causing adverse chemical changes in the battery. Specific examples thereof may be graphite such as natural graphite or artificial graphite; carbon based materials such as carbon black, acetylene black, Ketjen black, channel black, furnace black, lamp black, thermal black, and carbon fibers; powder or fibers of metal such as copper, nickel, aluminum, and silver; conductive whiskers such as zinc oxide whiskers and potassium titanate whiskers; conductive metal oxides such as titanium oxide; or conductive polymers such as polyphenylene derivatives, and any one thereof or a mixture of two or more thereof may be used. The conductive agent may be typically included in an amount of 1 wt % to 30 wt % based on a total weight of the electrode material mixture layer.

The binder, the first binder, and the second binder improve the adhesion between negative electrode active material particles and the adhesion between the negative electrode active material and the current collector. Specific examples thereof may be polyvinylidene fluoride (PVDF), polyvinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer rubber (EPDM rubber), a sulfonated EPDM, a styrene-butadiene rubber (SBR), a fluorine rubber, or various copolymers thereof, and any one thereof or a mixture of two or more thereof may be used. The binder may be included in an amount of 1 wt % to 30 wt % based on the total weight of the electrode material mixture layer.

The electrode material mixture layer, for example, may be prepared by coating the current collector with a composition for forming an electrode, which includes the negative electrode active material, the binder, and the conductive agent, and drying the coated current collector, or may be prepared by casting the composition for forming an electrode on a separate support and then laminating a film separated from the support on the current collector.

Also, as another method, the electrode may be prepared by casting the composition for forming an electrode material mixture layer on a separate support and then laminating a film separated from the support on the positive electrode collector.

With respect to the electrode for a secondary battery according to the present invention, a ratio of a maximum value (σₘₐₓ) to a minimum value (σₘᵢₙ) of shear strength in a regression curve obtained by a shear strength analysis method to be described later is 1.7 or less.

According to the study of the present inventors, in a case in which the maximum value to the minimum value of the shear strength in the regression curve obtained by the shear strength analysis method satisfies the above ratio, cohesive failure in the electrode material mixture layer is less, and, accordingly, excellent life characteristics are exhibited when the electrode is used in a secondary battery.

Particularly, with respect to a multilayer electrode, cohesive failure, particularly, interlayer cohesive failure in the electrode may be intensified due to differences in adhesion and strengths of different electrode active materials, and, accordingly, life characteristics may be degraded when the multilayer electrode is used in a secondary battery. However, the multilayer electrode for a secondary battery of the present invention, in which the ratio of the maximum value (σₘₐₓ) to the minimum value (σₘᵢₙ) of the shear strength in the regression curve obtained by the following shear strength analysis method satisfies 1.7 or less, may exhibit excellent lifetime characteristics and capacity characteristics due to significantly less cohesive failure, particularly, less interlayer cohesive failure in the electrode material mixture layer during operation of the secondary battery.

The shear strength analysis method of the present invention is performed in such a manner that, after shear strength (σ) data according to a cutting depth are obtained while cutting the electrode material mixture layer from a surface thereof until reaching the current collector using a surface and interfacial cutting analysis system (SAICAS) and a regression analysis is performed on the shear strength (σ) data to obtained a regression curve, a ratio of a maximum value to a minimum value of shear strength in the regression curve is compared.

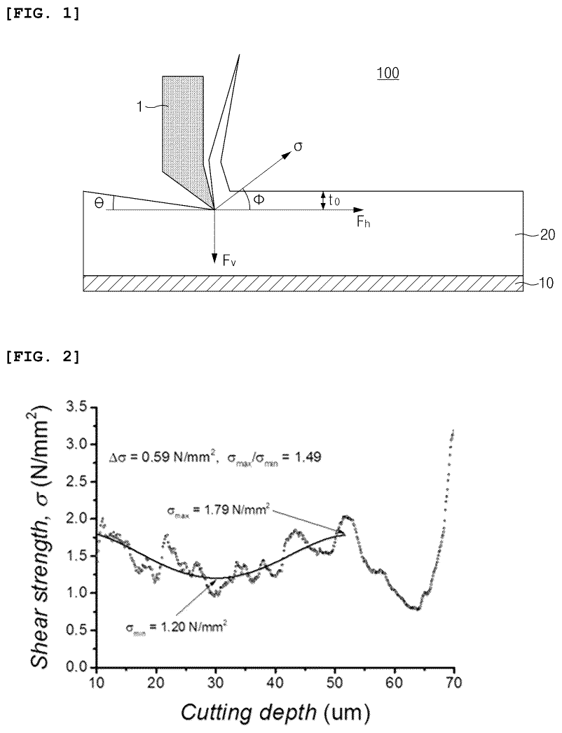

The surface and interfacial cutting analysis system (SAICAS) includes a device for obliquely cutting a coated thin film sample from a surface thereof to an interface using a blade, wherein it is a system that may measure a force applied to the blade during a cutting process. FIG. 1 is a view illustrating a process of cutting an electrode material mixture layer using the surface and interfacial cutting analysis system (SAICAS). As illustrated in FIG. 1, a blade 1 obliquely cuts an electrode material mixture layer 20 formed on a current collector 10 at a specific cutting angle θ with respect to a surface. In a case in which the cutting is performed with a cutting angle as described above, cutting is performed while the blade descends diagonally in a depth direction of the electrode material mixture layer. The cutting of the electrode material mixture layer is performed until the blade reaches the current collector.

In this case, the cutting angle θ may be in a range of greater than 0° to 10° or less, preferably 1° to 5.7°, and more preferably 3° to 5.7°. Since the cutting angle θ is set within the above range, measurement time may not only be shortened, but accuracy of the shear strength data may also be improved.

Also, a running speed of the blade during the cutting of the electrode material mixture layer may be in a range of about 0.01 μm/s to about 10 μm/s in a horizontal direction and about 0.001 μm/s to about 1 μm/s in a vertical direction. Preferably, the running speed of the blade may be in a range of 0.1 μm/s to 1 μm/s in the horizontal direction and 0.01 μm/s to 0.1 μm/s in the vertical direction, and may be more preferably in a range of 0.1 μm/s to 0.5 μm/s in the horizontal direction and 0.01 μm/s to 0.05 μm/s in the vertical direction. Since resolution of the shear strength data is improved by adjusting the running speed of the blade within the above range, the accuracy of the data is improved.

The blade is not particularly limited as long as it has a hardness higher than the electrode material mixture layer and its shape is not deformed in a cutting process, and, for example, the blade may be formed of a material, such as diamond, cubic boron nitride (BN), steel, cermet, and ceramic, and may more preferably be formed of cubic boron nitride (BN).

The blade, for example, may have a width of 0.1 mm to 4 mm, for example, 0.3 mm to 1 mm.

If the surface and interfacial cutting analysis system (SAICAS) is used, a horizontal force Fₕ and a vertical force Fᵥ, which are applied to the blade in the cutting process, may be measured. Thus, the horizontal force Fₕ and the vertical force Fᵥ, which are applied to the blade according to a cutting depth to, are measured using the surface and interfacial cutting analysis system (SAICAS), and shear strength (σ) data according to the cutting depth may be obtained by using the measured values.

Specifically, the shear strength (σ) may be calculated by the following Equation 1.

$$σ = \frac{{F}_{h} cos Φsin Φ - {F}_{v} {sin}^{2} Φ}{{bt}_{0}} \qquad [ Equation 1 ]$$

In Equation 1, σ is the shear strength (N/mm²), Fₕ is the horizontal force (N) applied to the blade which is measured by the surface and interfacial cutting analysis system, Fᵥ is the vertical force (N) applied to the blade which is measured by the surface and interfacial cutting analysis system, Φ is the shear angle (°), b is the blade width (mm), and t₀ is the cutting depth (μm).

After obtaining the shear strength data according to the cutting depth by the above processes, a regression analysis is performed on the shear strength data to obtain a regression curve. Fluctuation due to deformation of electrode particles exists in the shear strength (σ) data previously obtained by Equation 1 using the surface and interfacial cutting analysis system (SAICAS). A minimum value and a maximum value in the shear strength (σ) data may be clearly and simply selected by simplifying the shear strength data through the regression analysis.

In this case, the regression curve may be obtained through polynomial regression, and, more specifically, may be obtained by using a fourth-order polynomial regression equation represented by Equation 2 below. In this case, x-axis of the regression curve represents the cutting depth, and y-axis represents the shear strength.

$$σ = {A}_{0} + {A}_{1} d + {A}_{2} {d}^{2} + {A}_{3} {d}^{3} + {A}_{4} {d}^{4} \qquad [ Equation 2 ]$$

In Equation 2, σ is the shear strength (N/mm²), A₀, as shear strength when the cutting depth is 0 μm, is a positive number, A₁, A₂, A₃, and A₄ are constants obtained by the polynomial fourth-order equation, and d is the cutting depth (μm).

No shear force is applied to the blade at an interface between the electrode material mixture layer and the current collector, and, as a result, the shear strength rapidly decreases. That is, a location where a shear strength value starts to decrease rapidly may be regarded as the interface between the electrode material mixture layer and the current collector. Since maximum and minimum value data of shear strength may be distorted when a shear strength value at the interface between the electrode material mixture layer and the current collector is included, it is desirable that a regression curve is obtained by excluding shear strength data of a section in which the shear strength value rapidly decreases.

Next, a minimum value (σₘᵢₙ) and a maximum value (σₘₐₓ) of shear strength are obtained in the regression curve obtained as described above, and a ratio (σₘₐₓ/σₘᵢₙ) of the maximum value to the minimum value is calculated.

In the electrode for a secondary battery of the present invention, the ratio of the maximum value (σₘₐₓ) to the minimum value (σₘᵢₙ) of the shear strength, which has been obtained by the above-described processes, satisfies 1.7 or less. Preferably, the ratio of the maximum value (σₘₐₓ) to the minimum value (σₘᵢₙ) of the shear strength may be in a range of 1 to 1.7, and may be more preferably in a range of 1 to 1.6, for example, 1.2 to 1.6. In a case in which the ratio of the maximum value (σₘₐₓ) to the minimum value (σₘᵢₙ) of the shear strength is greater than 1.7, since the shear strength is non-uniform in a thickness direction of the electrode material mixture layer, cohesive failure easily occurs in the electrode material mixture layer when cycle repetition and external impact occur, and, as a result, the life characteristics may be rapidly degraded. Particularly, with respect to a multilayer electrode including two or more electrode material mixture layers with different compositions (components and/or contents), cohesive failure may be intensified at an interlayer interface due to differences in interlayer adhesion and strengths of the different electrode active materials. However, in a case in which an electrode satisfying the shear strength ratio of the present invention is used, since a variation in the shear strength in the thickness direction of the electrode material mixture layer is small, the cohesive failure in the electrode material mixture layer is minimized, and, as a result, excellent life characteristics may be obtained.

The ratio of the maximum value (σₘₐₓ) to the minimum value (σₘᵢₙ) of the shear strength is determined by the collective action of factors, for example, types or contents of components (i.e., active material, conductive material, and binder) constituting the electrode material mixture layer, strength of the particles, a thickness of the electrode material mixture layer, porosity, and electrode preparation process conditions such as rolling and drying temperature, etc. Thus, an electrode having a desired shear strength ratio may be prepared by appropriately adjusting a composition of the electrode material mixture layer and/or electrode process conditions.

Hereinafter, examples of the present invention will be described in detail in such a manner that it may easily be carried out by a person with ordinary skill in the art to which the present invention pertains. The invention may, however, be embodied in many different forms and should not be construed as being limited to the examples set forth herein.

### Example 1

Natural graphite as a first negative electrode active material, carbon black as a first conductive agent, and a carboxylmethyl cellulose (CMC) and a styrene butadiene rubber (SBR), as a first binder, were mixed in a weight ratio of 96.85:0.5:1.15:1.5 in a distilled water solvent to prepare a composition for forming a first negative electrode material mixture layer (solid content 40 wt %).

Also, artificial graphite as a second negative electrode active material, carbon black as a second conductive agent, and a carboxylmethyl cellulose (CMC) and a styrene butadiene rubber (SBR), as a second binder, were added at a weight ratio of 95.95:0.5:1.15:2.4 to distilled water and mixed to prepare a composition for forming a second negative electrode material mixture layer (solid content 40 wt %).

One surface of a copper current collector was coated with the composition for forming a first negative electrode material mixture layer and the composition for forming a second negative electrode material mixture layer, dried at 110° C. for 2 minutes, and then rolled to prepare a negative electrode which was composed of the current collector, a first negative electrode material mixture layer, and a second negative electrode material mixture layer.

### Example 2

Artificial graphite was used as a first negative electrode active material, the first negative electrode active material, a first conductive agent, and a first binder were mixed in a weight ratio of 95.35:0.5:1.15:3.0 to prepare a composition for forming a first negative electrode material mixture layer, artificial graphite was used as a second negative electrode active material, the second negative electrode active material, a second conductive agent, and a second binder were mixed in a weight ratio of 97.45:0.5:1.15:0.9 to prepare a composition for forming a second negative electrode material mixture layer, one surface of a copper current collector was coated with the composition for forming a first negative electrode material mixture layer and the composition for forming a second negative electrode material mixture layer, dried at 120° C. for 1 minute, and then rolled to prepare a negative electrode which was composed of the current collector, a first negative electrode material mixture layer, and a second negative electrode material mixture layer.

### Example 3

A negative electrode was prepared in the same manner as in Example 1 except that one surface of a copper current collector was coated with the composition for forming a first negative electrode material mixture layer and the composition for forming a second negative electrode material mixture layer, and then dried at 110° C. for 1 minute and 30 seconds to prepare the negative electrode.

### Comparative Example 1

Natural graphite was used as a first negative electrode active material, the first negative electrode active material, a first conductive agent, and a first binder were mixed in a weight ratio of 95.35:0.5:1.15:3.0 to prepare a composition for forming a first negative electrode material mixture layer, artificial graphite was used as a second negative electrode active material, the second negative electrode active material, a second conductive agent, and a second binder were mixed in a weight ratio of 97.45:0.5:1.15:0.9 to prepare a composition for forming a second negative electrode material mixture layer, one surface of a copper current collector was coated with the composition for forming a first negative electrode material mixture layer and the composition for forming a second negative electrode material mixture layer, dried at 120° C. for 1 minute, and then rolled to prepare a negative electrode which was composed of the current collector, a first negative electrode material mixture layer, and a second negative electrode material mixture layer.

### Comparative Example 2

A negative electrode was prepared in the same manner as in Example 1 except that a weight ratio of the composition for forming a first negative electrode material mixture layer was set at 96.5:0.5:1:2 and a weight ratio of the composition for forming a second negative electrode material mixture layer was set at 97.5:0.5:1.0:1.0.

### Comparative Example 3

A negative electrode was prepared in the same manner as in Example 1 except that one surface of a copper current collector was coated with the composition for forming a first negative electrode material mixture layer and the composition for forming a second negative electrode material mixture layer, and then dried at 120° C. for 1 minute to prepare the negative electrode.

### Experimental Example 1: Shear Strength (σ) Analysis

### (1) Shear Strength (σ) Data Measurement

For each of the negative electrodes prepared according to Examples 1 to 3 and Comparative Examples 1 to 3, forces applied to a blade according to a cutting depth were measured while performing oblique cutting of the negative electrode material mixture layer using a surface and interfacial cutting analysis system (SAICAS, SAICAS-DN, Dipla Wintes, Japan) equipped with the cubic boron nitrate blade, and shear strength (σ) according to the cutting depth was obtained by Equation 1.

In this case, the oblique cutting was performed in such a manner that, after the blade was positioned parallel to a surface of the electrode material mixture layer until 0.03 N of vertical force was applied, the blade was advanced at a horizontal velocity of 0.5 μm/s, a vertical velocity of 0.05 μm/s, and a cutting angle of 5.7° in a constant velocity mode.

Then, the shear strength (σ) data obtained were analyzed by using a fourth-order polynomial regression equation to obtain a regression curve.

The shear strength data and regression curve of each electrode, which were obtained by the above method, are illustrated in graphs of FIGS. 2 to 7.

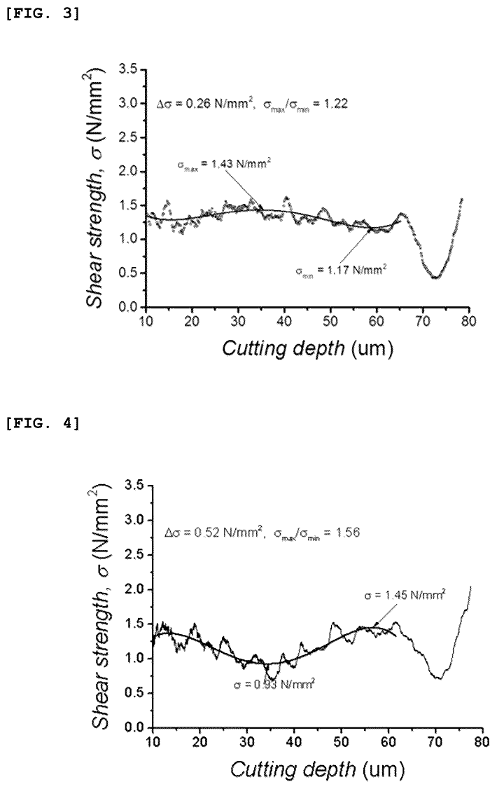

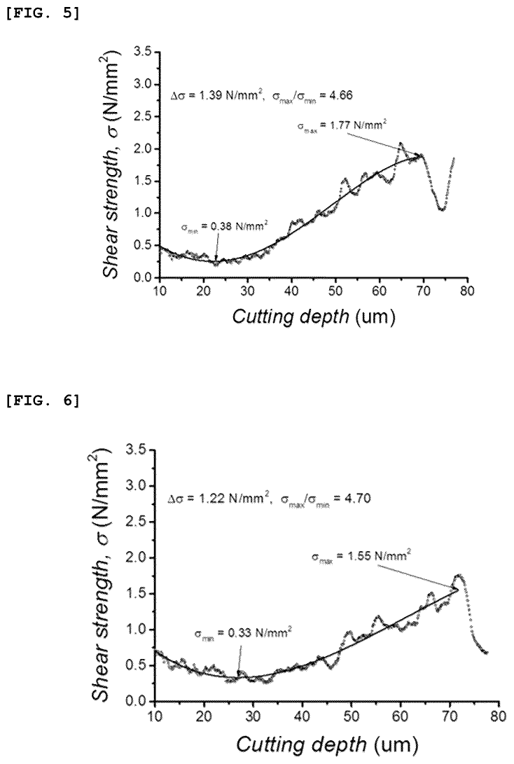

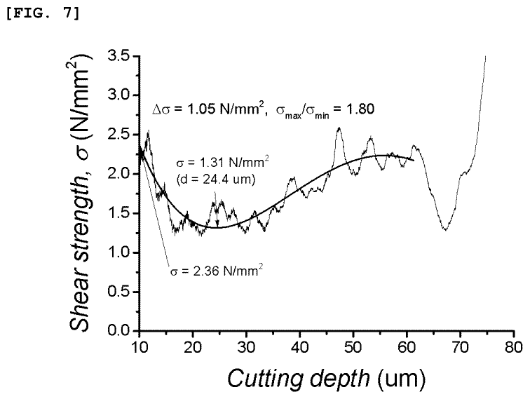

A minimum value (σₘᵢₙ) and a maximum value (σₘₐₓ) of shear strength, and a ratio of the maximum value (σₘₐₓ) to the minimum value (σₘᵢₙ) were obtained from each regression curve illustrated in FIG. 2 (Example 1), FIG. 3 (Example 2), FIG. 4 (Example 3), FIG. 5 (Comparative Example 1), FIG. 6 (Comparative Example 2), and FIG. 7 (Comparative Example 3), and the results thereof are presented in Table 1 below.

TABLE 1

| | Maximum value | Minimum value | |
|---|---|---|---|
| | (σₘₐₓ) (N/mm²) | (σₘᵢₙ) (N/mm²) | σₘₐₓ/σₘᵢₙ |
| Example 1 | 1.79 | 1.20 | 1.49 |
| Example 2 | 1.43 | 1.17 | 1.22 |
| Example 3 | 1.45 | 0.93 | 1.56 |
| Comparative | 1.77 | 0.38 | 4.66 |
| Example 1 | | | |
| Comparative | 1.55 | 0.33 | 4.70 |
| Example 2 | | | |
| Comparative | 2.36 | 1.31 | 1.80 |
| Example 3 | | | |

Referring to Table 1, it may be confirmed that, with respect to the negative electrodes of Examples 1 to 3, the ratios of the maximum value (σₘₐₓ) to the minimum value (σₘᵢₙ) satisfied 1.7 or less, but, with respect to the negative electrodes of Comparative Examples 1 to 3, the ratios of the maximum value (σₘₐₓ) to the minimum value (σₘᵢₙ) were greater than 1.7.

### Experimental Example 2: Life Characteristics Evaluation

A LiCoO₂ positive electrode active material, a carbon black conductive agent, and a PVdF binder were mixed in an N-methylpyrrolidone solvent at a weight ratio of 96:2:2 to prepare a positive electrode material mixture (viscosity: 5000 mPa·s), and one surface of an aluminum current collector was coated with the positive electrode material mixture, dried at 130° C., and then rolled to prepare a positive electrode.

Each of the negative electrodes prepared in Examples 1 to 3 and Comparative Examples 1 to 3 was used as a negative electrode.

Each lithium secondary battery was prepared by preparing an electrode assembly by disposing a porous polyethylene separator between the positive electrode and negative electrode prepared as described above, disposing the electrode assembly in a case, and then injecting an electrolyte solution into the case. In this case, the electrolyte solution was prepared by dissolving 1.0 M lithium hexafluorophosphate (LiPF₆) in an organic solvent composed of ethylene carbonate/ethylmethyl carbonate/diethyl carbonate (mixing volume ratio of EC/EMC/DEC=3/4/3).

Each of the above-prepared lithium secondary batteries with a battery capacity of 50 mAh was charged at 2.5 V and a constant current of 0.33 C until the voltage became 4.25 V, and was subsequently charged at a constant voltage of 4.25 V, and the charge was terminated when the charge current became 2.5 mA. Thereafter, after being left standing for 30 minutes, each lithium secondary battery was discharged at a constant current of 0.33 C to a voltage of 2.5 V to measure initial capacity. Thereafter, each secondary battery was charged at 2.5 V and a constant current of 1 C at 25° C. until the voltage became 4.25 V, and was subsequently charged at a constant voltage of 4.25 V, and the charge was terminated when the charge current became 2.5 mA. Thereafter, after being left standing for 30 minutes, each secondary battery was discharged at a constant current of 1 C to a voltage of 2.5 V to measure capacity retention when 200 cycles of charge and discharge were performed. The results thereof are presented in Table 2.

TABLE 2

| | Capacity retention (%) |
|---|---|
| | (@ 200^{th} cycle) |
| Example 1 | 96.4 |
| Example 2 | 95.0 |
| Example 3 | 92.5 |
| Comparative Example 1 | 82.3 |
| Comparative Example 2 | 84.9 |
| Comparative Example 3 | 89.2 |

Referring to Table 2, it may be confirmed that the secondary batteries respectively using the negative electrodes of Examples 1 to 3, in which the ratio of the maximum value (σₘₐₓ) to the minimum value (σₘᵢₙ) of the shear strength was 1.7 or less, had significantly better life characteristics than the secondary batteries respectively using the negative electrodes of Comparative Examples 1 to 3 in which the ratio of the maximum value (σₘₐₓ) to the minimum value (σₘᵢₙ) of the shear strength was greater than 1.7.

The electrode for a secondary battery according to the present invention may suppress cohesive failure, particularly, interlayer cohesive failure in the electrode material mixture layer during operation of the lithium secondary battery, and may exhibit excellent life characteristics and capacity characteristics while having cost competitiveness.

Particularly, with respect to a multilayer electrode in which artificial graphite having excellent life characteristics and capacity characteristics and natural graphite having excellent strength and adhesion are formed in multi-layers, cohesive failure, particularly, interlayer cohesive failure in the electrode, which occurs due to differences in adhesion and strengths between the artificial graphite and the natural graphite, may be suppressed, and life characteristics may be improved.

What is claimed is:

1. A secondary battery, comprising:
a positive electrode;
a negative electrode; and
an electrolyte,
wherein the negative electrode comprises a current collector and at least one electrode material mixture layer on a surface of the current collector, the at least one electrode material mixture layer comprising a negative electrode active material, a conductive agent, and a binder,
wherein, the negative electrode has a property such that in a regression curve obtained by regression analysis of shear strength data according to a cutting depth which are measured while obliquely cutting the electrode material mixture layer from a surface thereof until reaching the current collector using a surface and interfacial cutting analysis system (SAICAS), a ratio of a maximum value (σₘₐₓ) to a minimum value (σₘᵢₙ) of shear strength is greater than 1 and equal to or less than 1.7.

2. The secondary battery of claim 1, wherein the ratio of the maximum value (σₘₐₓ) to the minimum value (σₘᵢₙ) of the shear strength in the regression curve is in a range of greater than 1 and equal to or less than 1.6.

3. The secondary battery of claim 1, wherein the electrode material mixture layer is obliquely cut at a cutting angle of greater than 0° and equal to or less than 10° when the surface and interfacial cutting analysis system (SAICAS) is used.

4. The secondary battery of claim 1, wherein a running speed of a blade is in a range of 0.01 μm/s to 10 μm/s in a horizontal direction and 0.001 μm/s to 1 μm/s in a vertical direction when the surface and interfacial cutting analysis system (SAICAS) is used.

5. The secondary battery of claim 1, wherein the shear strength data according to the cutting depth is calculated by Equation 1:
$$σ = \frac{{F}_{h} cos Φsin Φ - {F}_{v} {sin}^{2} Φ}{{bt}_{0}} \qquad [ Equation 1 ]$$
wherein, in Equation 1, σ is shear strength (N/mm²), Fₕ is a horizontal force (N) applied to a blade which is measured by the surface and interfacial cutting analysis system, Fᵥ is a vertical force (N) applied to the blade which is measured by the surface and interfacial cutting analysis system, Φ is a shear angle (°), b is a blade width (mm), and t₀ is a cutting depth (μm).

6. The secondary battery of claim 1, wherein the regression curve is obtained by performing a fourth-order polynomial regression analysis on the shear strength data.

7. The secondary battery of claim 1, wherein the at least one electrode material mixture layer comprises:
a first electrode material mixture layer on the surface of the current collector and comprising a first negative electrode active material, a first conductive agent, and a first binder; and
a second electrode material mixture layer on a surface of the first electrode material mixture layer opposite the current collector and comprising a second negative electrode active material, a second conductive agent, and a second binder.

8. The secondary battery of claim 7, wherein the first negative electrode active material and the second negative electrode active material are different from each other.

9. The secondary battery of claim 7, wherein the first negative electrode active material comprises natural graphite, and the second negative electrode active material comprises artificial graphite.

10. The secondary battery of claim 1, wherein the electrolyte comprises a lithium salt and an organic solvent.

11. The secondary battery of claim 1, wherein the negative electrode active material comprises natural graphite, artificial graphite, graphitized carbon fibers, amorphous carbon, silicon (Si), aluminum (Al), tin (Sn), lead (Pb), zinc (Zn), bismuth (Bi), indium (In), magnesium (Mg), gallium (Ga), cadmium (Cd), a Si alloy, a Sn alloy, an Al alloy, SiO_{β} (0<β<2), SnO₂, vanadium oxide, lithium vanadium oxide, a Si—C composite, or a Sn—C composite.

12. The secondary battery of claim 1, wherein the conductive agent comprises natural graphite, artificial graphite, carbon black, acetylene black, Ketjen black, channel black, furnace black, lamp black, thermal black, carbon fibers, copper, nickel, aluminum, silver, zinc oxide whiskers, potassium titanate whiskers, titanium oxide, polyphenylene derivatives, or a combination thereof.

13. The secondary battery of claim 1, wherein the binder comprises polyvinylidene fluoride (PVDF), polyvinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer rubber (EPDM rubber), a sulfonated EPDM, a styrene-butadiene rubber (SBR), a fluorine rubber or a combination thereof.

14. The secondary battery of claim 1, wherein the current collector comprises copper; stainless steel; aluminum; nickel; titanium; fired carbon; copper or stainless steel that is surface-treated with carbon, nickel, titanium or silver; or an aluminum-cadmium alloy.

15. The secondary battery of claim 1, wherein the current collector has a thickness in a range of 3 μm to 500 μm.

16. The secondary battery of claim 1, wherein the conductive agent is included in an amount of 1 wt % to 30 wt % based on a total weight of the electrode material mixture layer.

17. The secondary battery of claim 1, wherein the binder is included in an amount of 1 wt % to 30 wt % based on the total weight of the electrode material mixture layer.

18. The secondary battery of claim 1, further comprising a separator.

19. The secondary battery of claim 10, wherein the lithium salt in the electrolyte comprises lithium hexafluorophosphate (LiPF₆).

20. The secondary battery of claim 10, wherein the organic solvent in the electrolyte comprises a mixture of ethylene carbonate, ethylmethyl carbonate, and diethyl carbonate.
